(19) United States
(12) Patent Application Publication
(10) Pub. No.: US 2005/0118067 A1
(43) Pub. Date: Jun. 2, 2005

(54) Device to print biofluids

(76) Inventor: Jaan Noolandi, palo Alto, CA (US)

Correspondence Address: SQUIRE, SANDERS & DEMPSEY L.L.P, 600 HANSEN WAY, PALO ALTO, CA, 94304-1043, US

(21) Appl. No.: 10/503,693

(22) PCT Filed: Feb. 12, 2003
(86) PCT No.: PCT/US03/04192

(51) Int. Cl. B01L 3/02

(52) U.S. Cl. 422/100; 436/180

(57) ABSTRACT

An apparatus and method of printing microarrays by ejecting droplets of electrically conducting liquids from wells (12) onto a substrate (21) on top of a charged plate (20) using electrodes (18) inserted into the wells (12).

This application claims benefit of U.S. Provisional Patent Application Ser. No. 60/355,962 filed Feb. 12, 2002, entitled Device for Printing Biofluids by Jaan Noolandi.

### BACKGROUND

1. Field of Invention

This invention relates to an apparatus and method of making microarrays, specifically to a way of ejecting liquid drops of biological fluids directly onto substrates from a fluid container with multiple fluid wells.

2. Description of Prior Art

Research protocols and clinical applications in genomics and proteomics depend on the ability to spot thousands of tiny drops of biological fluids on microscope slides and other substrates. An ability to spot microarrays quickly, reliably, and inexpensively is of considerable interest to researchers worldwide and is of significant commercial value.

Previous research can be divided into (a) current methods of spotting microarrays and (b) work on drop emission from single ejector nozzles. The current methods of spotting in laboratory and commercial environments are (i) are pin-based spotters (ii) photolithographic techniques, (iii) ink-jet print heads, and (iv) focused acoustic beams.

The contact pin-based spotter is the most common method of spotting in biotechnology laboratories. A robotic arm dips an array of pins into a well plate and the pins are moved to contact a substrate so that each pin leaves a small spot of biological fluid. This type of spotting is based on contact between the pins and substrate so it risks contamination, and the minimum fluid volume for pin dip leads to wastage.

Photolithographic techniques dominate the pre-made high density gene chip microarray market. However, they require elaborate nanofabrication masking techniques and bulky, expensive production equipment.

The work on single ejection nozzles does not show how to build a reliable, high throughput, inexpensive ejection device with a plurality of ejector nozzles that can be easily cleaned, protect the biological fluids, and interface with standard laboratory equipment in a modular fashion.

The present invention overcomes the limitations above. None of the previous efforts in this field disclose all of the benefits of the present invention, nor does the prior art teach or suggest all of the elements of the present invention.

### OBJECTS AND ADVANTAGES

An object of the present invention is to attain high throughput and inexpensive biological fluid handling by simultaneously ejecting drops of biological fluids from a container with many wells directly onto a substrate.

A further object of the present invention is to eliminate the intermediate step of moving the biological fluids from storage containers into ejection wells.

It is another object of the present invention to use containers which have wells conforming to but not limited to the established biotechnology industry standards, with 96, 384, or 1536 wells in electrically insulating well plates. The containers can be inexpensively made, discarded when empty, or cleaned and refilled with biological fluids, and conform in a modular fashion for use with automatic fluid handling systems.

It is another object of the present invention to increase reliability of spotting by covering the openings on both sides of the well plate with inexpensive protective covers to avoid spillage, evaporation, and contamination of the biological fluids before drop ejection. The use of membranes that are punctured by the electrodes during spotting also decreases the evaporation rate as well as contamination by leaving the openings effectively covered.

It is also an object of the present invention to provide a simple, robust, and reliable method and apparatus for ejecting biological fluids in wells of a well plate onto a substrate.

### SUMMARY

The apparatus of the present invention comprises: a non-conducting well plate modified by forming openings in the bottoms of the wells, which wells can each be filled with a different electrically conducting biological fluid; an array of conducting electrodes that can be dipped into the wells; a substrate located below the openings which is positioned on an electrical ground plane; and a power supply capable of applying electrical potential pulses to one or more electrodes at a time to form electric fields that cause the wells eject drops onto the substrate.

The method of the present invention consists of ejecting drops of electrically conducting biological fluids onto a substrate resting on an electrically grounded plate from openings in the wells on the underside of the well plate when voltage pulses from a power supply are applied to the conducting electrodes which have been immersed into the biological fluids within the wells of the well plate.

### DRAWINGS

Drawing Figures

One example of a method and apparatus according to the present invention will now be described with reference to the accompanying drawings in which:

FIG. 1 illustrates, diagrammatically, a view of the apparatus of the present invention.

FIG. 2 shows a modified 384-well plate for storing fluids.

FIG. 3 shows part of the apparatus of the present invention, in which the holes underneath the well plate connecting to the wells on the other side of the well plate are displayed.

FIG. 4 shows a sectional view of the conducting pins of the conducting electrode array at the top immersed into the fluids inside the wells of the well plate at the bottom.

FIG. 5 shows a detail of a conducting electrode immersed into the fluid of a well plate, with an opening connecting to the outside, above a ground plane covered by a substrate.

FIG. 6 shows the apparatus of the present invention, in which the wells of the well plate are uncovered.

### REFERENCE NUMERALS IN DRAWINGS

9 Cable leading to power supply
10 Device for printing biofluids
11 Well plate
12 Wells in well plate
13 Cover over wells in well plate
14 Opening on well plate connecting to biological fluid well
15 Channel connecting well in well plate to underside of well plate
16 Cover over holes on underside of well plate
17 Conducting electrode array
18 Conducting electrode
19 Molded plastic support for conducting electrode array
20 Electrical ground plane
21 Substrate covering ground plane
22 Biological fluid in well of well plate
23 Air gap between hole in bottom of well plate and substrate

### DETAILED DESCRIPTION

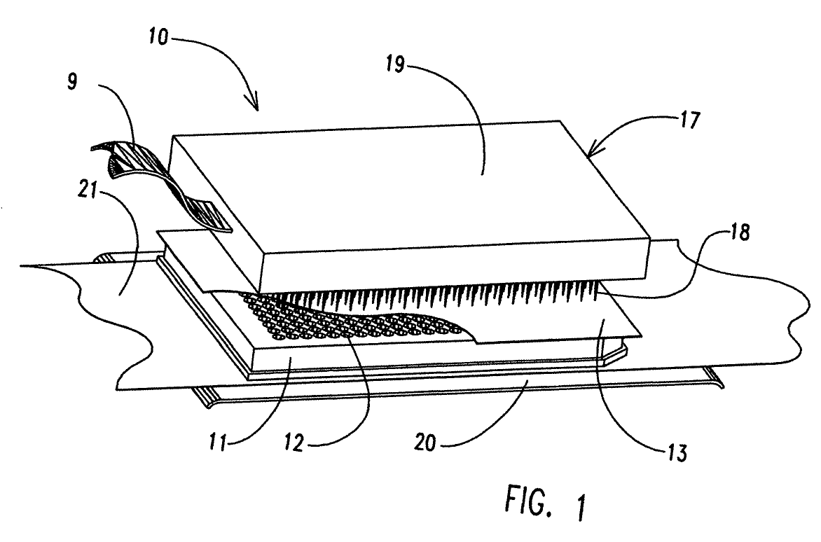

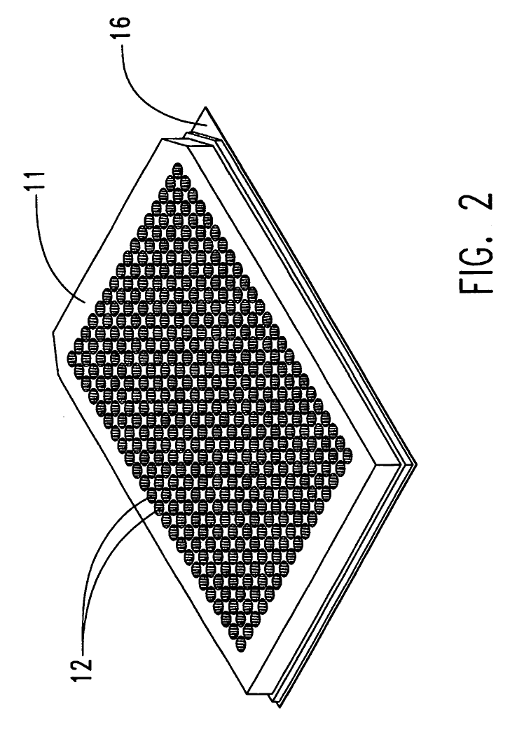

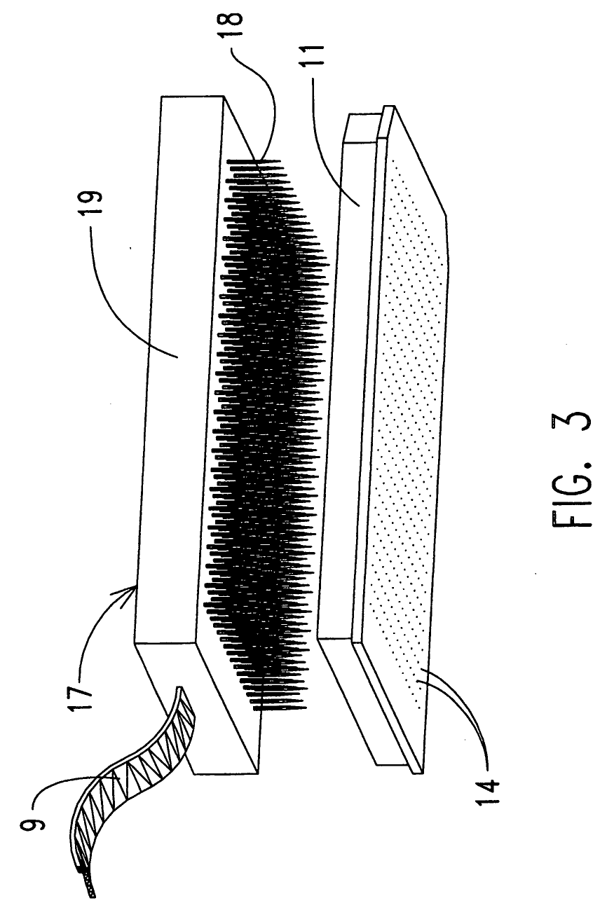

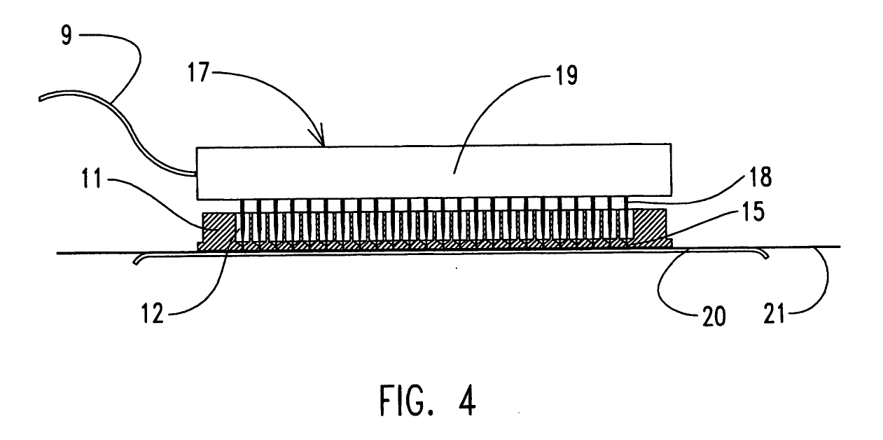

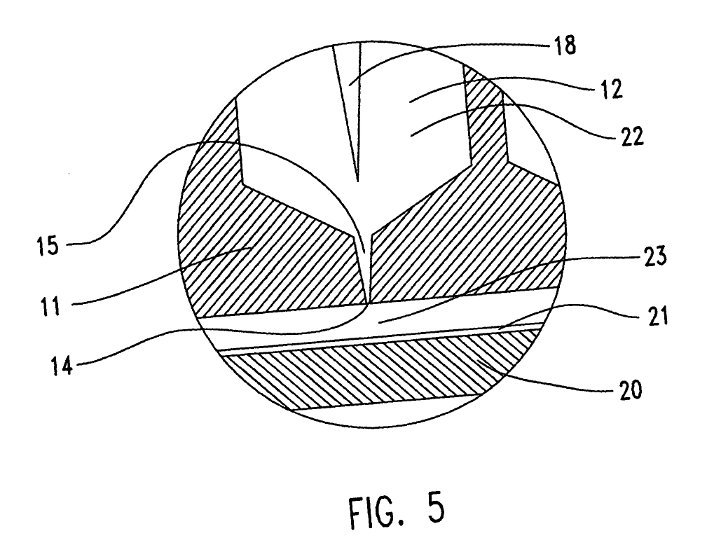

FIG. 1 shows the apparatus of the present invention, a device used to eject biological fluids onto a substrate, generally indicated by 10. The system 10 is connected by the cable 9 to a high voltage pulse generator. The bottom component 11 is a 384 well plate, shown in FIG. 2, which can be made out of molded plastic. Each of the wells 12 shown in FIG. 2 can be filled with a different biological fluid in aqueous solution. After filling each of the wells 12 with a fluid, a cover 13 in FIG. 1 can be attached over the surface of the well plate 11 to seal the wells 12 and to prevent leakage or evaporation. Typically each well 12 in the well plate 11 accommodates from 1 to 200 microliters of biological fluid. In the preferred embodiment 30 microliters of biological fluid are used. The cover 13 can be a piece of plastic or a membrane, for example 3M brand Scotch Tape. As shown in FIG. 3, each of the wells 12 also has a hole 14 preformed from the bottom of each well 12 through the plate material to the other side, providing a channel 15, shown in FIGS. 4 and 5, for the fluid to leave the well 12 by as described below. The hole 14 at the bottom of each well has a diameter of 120 microns in the preferred embodiment, but can range from 10 microns to 300 microns. The underside of the well plate 11 has a cover 16, typically an adhesive membrane, shown in FIG. 2, which can be removed. The adhesive membrane can be 3M brand Scotch Tape.

FIG. 1 also shows the conducting electrode array 17, consisting of 384 conducting electrodes 18 embedded in molded plastic 19, such that the conducting electrode array 17 fits over the well plate 11, with the conducting electrodes 18 inserted into each of the wells 12. In other embodiments, the wells 12 can range in number from 2 to 10,000. In the preferred embodiment, the number of electrodes 18 matches the number of wells. In another embodiment there can be fewer electrodes than wells. In the preferred embodiment, the conducting electrodes are stainless steel pins. In other embodiments any non-reactive conductor may be used. When the conducting electrode array 17 is aligned with the well plate 11, the conducting electrodes 18 can be pushed through the membrane 13 covering the wells 12. This leaves the wells 12 covered and minimizes evaporation and contamination. Each of the conducting electrodes 18 in the conducting electrode array 17 is connected to power supply that can supply 500 volts to 4,000 volts, with 3,000 volts in the preferred embodiment. The voltage can be pulsed from 0.2 milliseconds to 20 milliseconds, and is pulsed for 2 milliseconds in the preferred embodiment. In another embodiment, the electrodes are embedded in the material forming the wells 12 and these are connected to the power supply.

The conducting plate 20 is shown in FIG. 5, covered by a substrate 21 which can be but is not limited to glass, nitrocellulose, and nylon, onto which drops of biological fluid 22 are ejected from the wells 12 of the well plate 11.

Operation of Invention

The process of printing biological fluids 22, shown in FIG. 5, onto the substrate 21 is described as follows: the adhesive tape 16 (shown in FIG. 2) covering the underside of the well plate 11 (containing pre-filled biological fluids 22) is removed. The well plate 11 is positioned as shown in FIG. 1 above the substrate. The conducting electrodes 18 of the conducting electrode array 17 are positioned over the well plate 11, as shown in FIG. 1, lowered to puncture the membrane 13 covering the wells 12, and immersed into the biological fluid 22 (see FIG. 5) in each well 12. The device for printing biofluids 10 of FIG. 1 is positioned above a substrate 21 (see FIG. 5) covering a conducting plane 20, with a gap from the opening 14 on the bottom of the well plate to the ground plane 20 of 50 microns to 1,000 microns, as shown in FIG. 5, with 400 microns in the preferred embodiment. The air gap from the opening 14 on the bottom of the well plate 11 to the substrate 21 can be in the range 30 microns to 900 microns, with 250 microns in the preferred embodiment. An electrical pulse is selectively transmitted through the conducting electrodes 18 into the biological fluids 22, which are also conducting since they consist of aqueous ionic solutions of biological entities. FIG. 5 shows an arrangement for one of the wells 12 in the well plate 11.

The configuration for spotting a 20 microliter volume of plasmid DNA (12 kiobases) in 10 mM Tris-Acetate buffer pH 8.2 onto a nitrocellulose substrate can be: nozzle interior diameter of 120 microns, a gap from nozzle to ground plane of 400 microns, and a 3,000 Volt electrical pulse for 2 milliseconds duration.

A number of strategies can be used for applying voltage pulses to achieve drop ejection onto the substrate. The electrical potential pulse can be an oscillating voltage, which causes ejection of a biological fluid from a well, or the oscillating voltage causing drop ejection can be superimposed on a second voltage which by itself is not enough to cause drop ejection.

By controlling the electrical pulses on the conducting electrodes 18 in the conducting electrode array 17 in FIG. 4, a number of drops can be printed onto a substrate 21, shown in FIG. 4, underneath a stationary conducting electrode array 17. After one substrate is printed, a new substrate can be put in its place. The printing can thusly proceed to spot many substrates 21 until the well plate 12 is empty, at which point it can be discarded or cleaned and reused. The conducting electrodes 18 in the conducting electrode array 17 can then be washed and reused for printing from another well plate 11.

As shown in FIG. 1, the substrate 21 can be positioned below the well plate 11. Since our modified well plate 11 in FIG. 1 becomes, in effect, a 384 nozzle biological fluid printing device 10, we are able to print 384 spots from the single well plate 11 onto a substrate 21, as shown in FIG. 1.

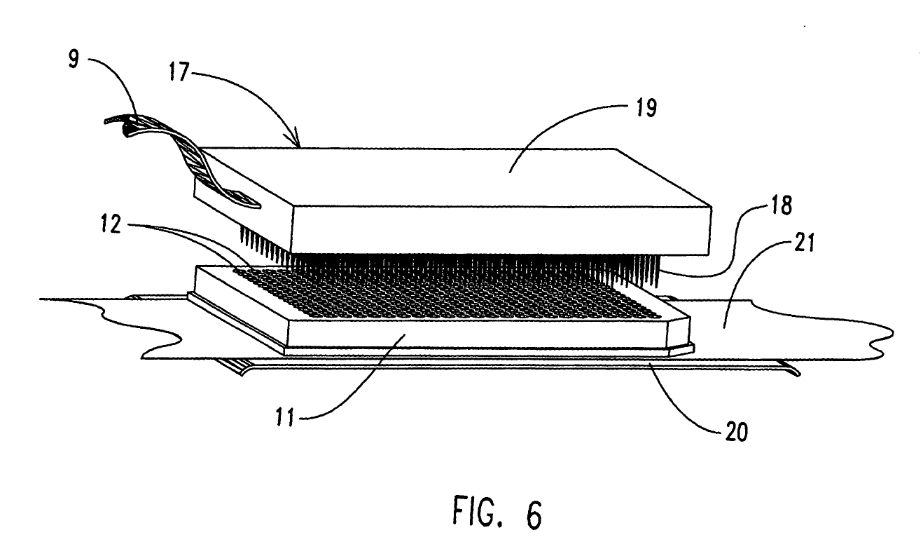

FIG. 6 shows the apparatus of the invention in which the cover 13 covering the well plate 11 shown in FIG. 1 has been removed.

### CONCLUSION, RAMIFICATIONS, AND SCOPE

The present invention is a simple, non-contact, modular printing system with low likelihood of biological fluid contamination and which enables a rapid rate of drop delivery to a substrate. In an embodiment used in a high-performance system, either a single well plate with a few thousand wells or many well plates in a row can all be made to eject simultaneously so that high throughputs can be achieved. Experts predict clinical applications of microarrays will require pharmaceutical companies to produce millions of microarrays. The present invention is capable of economically meeting this need.

The present invention has important applications in combinatorial chemistry, which is an important research tool for drug design and development. Combinatorial chemistry involves putting many fluids into containers (well plates), carrying out assays and removing the fluids to find the optimal proportions for chemical reactions.

Biotechnology laboratories and Genome Centers require an easy-to-use and reliable spotting system for monitoring the expression of many genes in parallel, which is provided by the present invention.

An important application for structural genomics research and structure-based drug discovery is the efficient preparation of protein crystals using nanodroplets. The high-throughput system described in this invention for drop generation and delivery of biological fluids consisting of dissolved proteins to a substrate will facilitate research in this field as well.

Accordingly, the scope of the present invention should be determined not by the embodiments described above, but by the appended claims and their legal equivalents.

1. An apparatus to eject drops of electrically conducting biological fluids onto a substrate, said apparatus comprising:
(a) an electrically insulating container with a plurality of fluid wells, each well having a first opening on one side of the container, and a second opening on the other side of the container, said second openings being the ejection locations;
(b) a non-conducting substrate adjacent to said ejection locations;
(c) a conducting ground plane adjacent to said substrate; and
(d) a power supply capable of applying an electrical potential pulse to said fluid in one or more wells at a time to form electric fields at the ejection locations, whereby the wells eject drops from their openings onto said substrate.

2. The apparatus of claim 1, wherein said biological fluid contains DNA.

3. The apparatus of claim 1, wherein said biological fluid contains proteins.

4. The apparatus of claim 1, wherein said biological fluid contains viruses

5. The apparatus of claim 1, wherein said biological fluid contains cells.

6. The apparatus of claim 1, wherein said substrate is planar.

7. The apparatus of claim 1, wherein said electric potential is oscillating.

8. The apparatus of claim 1, wherein said electric potential is an oscillating potential superimposed on top of a constant potential.

9. The apparatus of claim 1, wherein said container and its wells are substantially the same size and shape as one of 96 well plates, 384 well plates, and 1536 well plates.

10. The apparatus of claim 1, wherein said container and its wells are the same size and shape as biotechnology containers.

11. The apparatus of claim 1 wherein the power supply supplies potential to electrodes that are capable of being removably inserted into said first openings.

12. The apparatus of claim 11 wherein the wells in the container are protected by:
(a) a first cover covering the first openings which is removed prior to drop ejections; and
(b) a second cover covering said second openings which is removed prior to drop ejections.

13. The apparatus of claim 12, wherein said first cover is replaced with said first cover or a new cover after drop ejection.

14. The apparatus of claim 12, wherein said second cover is replaced with said second cover or a new cover after drop ejection.

15. The apparatus in claim 11 wherein a third cover covers said first openings and said electrodes are capable of penetrating said third cover when they are inserted into said first openings.

16. The apparatus of claim 15, wherein said electrodes are shaped like needles.

17. A method for ejecting discrete drops of electrically conducting biological fluids onto a substrate, said method comprising:
placing each fluid in an electrically insulating container with a plurality of fluid wells, each well having a first opening on one side of the container, and a second opening on the other side of the container, said second openings being the ejection locations;
placing a non-conducting substrate adjacent to said ejection locations;
placing a conducting ground plane adjacent to said substrate away from said second openings; and
applying an electrical potential pulse to the fluid in one or more wells at a time to form electric fields at the ejection locations, whereby the wells will eject drops from their second openings onto said substrate.

18. The method of claim 17, wherein said biological fluid contains DNA.

19. The method of claim 17, wherein said biological fluid contains proteins.

20. The method of claim 17, wherein said biological fluid contains viruses

21. The method of claim 17, wherein said biological fluid contains cells.

22. The method of claim 17, wherein said substrate is planar.

23. The method of claim 17, wherein said electric potential is oscillating.

24. The method of claim 17, wherein said electric potential is an oscillating potential superimposed on top of a constant potential.

25. The method of claim 17, wherein the power supply supplies potential to electrodes that are capable of being removably inserted into said first openings.

26. The method of claim 17, wherein said wells in said container are protected by:
removing a first cover covering the first openings prior to drop ejections; and
removing a second cover covering said second openings prior to drop ejections.

27. The method of claim 26, wherein said first cover is replaced with said first cover or a new cover after drop ejection.

28. The apparatus of claim 26, wherein said second cover is replaced with said second cover or a new cover after drop ejection.

29. The method of claim 26, wherein a third cover covers said first openings and said electrodes penetrate said third cover when they are inserted into said first openings.

30. The method of claim 29, wherein the electrodes are shaped like needles.

31. A microarray exceeding a density of 100 spots/cm² produced by the method of claim 17.

32. A microarray having a cost less than $0.001(US) per spot produced by the method of claim 17.
